(19) United States
(12) Patent Application Publication
(10) Pub. No.: US 2004/0200560 A1
(43) Pub. Date: Oct. 14, 2004

(54) Wallcovering for use on irregular surfaces

(76) Inventors: Francis J. Babineau JR., Parker, CO (US); Donald R. Steinle, Littleton, CO (US); Glenda Beth Bennett, Toledo, OH (US); Alan Michael Jaffee, Bowling Green, OH (US)

Correspondence Address: Robert D. Touslee, Johns Manville, 10100 West Ute Avenue, Littleton, CO, 80127, US

(21) Appl. No.: 10/412,466

(22) Filed: Apr. 11, 2003

(51) Int. Cl. B32B 35/00

(52) U.S. Cl. 156/71

(57) ABSTRACT

A method is disclosed for providing a substantially smooth surface on a wall substrate having a wall surface with surface irregularities. The method comprises applying an adhesive substantially uniformly to the surface of the wall substrate, and attaching to the wall surface a base sheet having sufficient stiffness, thickness and compressibility to conceal the surface irregularities and provide a substantially smooth surface on the wall substrate. In one aspect of the method, the base sheet is a nonwoven fiber glass mat.

### BACKGROUND OF THE INVENTION

1. Field of the Invention

The subject invention pertains to methods for providing a substantially smooth surface on walls with surface irregularities.

2. Description of the Related Art

Current methods for providing a smooth finish to irregular wall surfaces include plaster or tape & joint compound for paneling, unfinished gypsum board or concrete (poured or block) walls. Another option for paneling or concrete walls is to use furring strips (thin wood slats) and gypsum wallboard. These methods tend to be relatively expensive, time-consuming, potentially messy and require a certain amount of skill to complete. Furthermore, furring out an additional layer of gypsum wallboard may increase the wall thickness by an unacceptable amount.

Other methods of covering wall surface irregularities have also been proposed. U.S. Pat. No. 5,605,259 relates to a method and apparatus for covering irregularities in a wall surface involving applying drywall compound which is formulated to be flowable and placed into an aerosol container with a propellant material.

U.S. Pat. No. 5,820,958 describes providing a patch for cracks in interior walls which has a flexible or elastic membrane of uniform cross section that can be repeatedly stretched and released without rupturing.

U.S. Pat. No. 6,018,919 discloses a smooth wall finishing system which is a sheet material that covers the entire wall surface and bridges substrate irregularities by shrinking to a tight smooth surface. The material is made from a PVC compound formulated to meet code requirements.

There is still a need in the art for a method for providing a smooth finished surface to a rough or irregular wall surface. Moreover, a wallcovering is needed which provides a smooth surface for a rough or irregular wall surface in one installation step. Additionally, a method is desired which can shorten the time and reduce the cost required to finish an irregular wall surface, particularly such surfaces as unfinished gypsum wallboard, paneling or concrete. The present invention provides such a method.

### SUMMARY OF THE INVENTION

This invention is directed to a method whereby a rough or irregular wall surface is covered with a sheet material that has a sufficient stiffness, thickness and compressibility to conceal surface irregularities and/or damage.

In one aspect of the invention, a method for providing a substantially smooth surface on a wall substrate having a wall surface with surface irregularities is provided comprising applying an adhesive substantially uniformly to the wall surface and attaching to the wall surface a base sheet having sufficient stiffness, thickness and compressibility to conceal the surface irregularities. The result is a substantially smooth surface on the wall substrate.

In a further aspect of the invention, a method for providing a substantially smooth surface to a wall substrate having a wall surface with surface irregularities is provided comprising applying an adhesive substantially uniformly to the wall surface, and attaching to the wall surface a nonwoven fiber glass mat having sufficient stiffness, thickness and compressibility to conceal the surface irregularities.

### BRIEF DESCRIPTION OF DRAWINGS

FIG. 1 shows an example of the wallcovering system partially applied over a concrete block wall, showing the blocks, mortar joints, base sheet and finish wallcovering.

FIG. 2 shows a detail side view of a portion of a concrete block wall with the system applied, showing the blocks, mortar joints, base sheet, finish wallcovering and the adhesive layers.

### DETAILED DESCRIPTION OF THE INVENTION

This invention is directed to a method whereby a rough wall surface is covered with a base sheet with particular characteristics which allow for the base sheet to provide a substantially smooth surface to the rough wall surface, covering any irregularities in the surface of the wall. Any wall surface or substrate may be covered using the method of the invention, but the method is particularly useful in providing a substantially smooth surface on irregular wall surfaces such as unfinished gypsum wallboard, paneling or concrete block walls.

“Irregular wall surface” or “rough wail surface” are used interchangeably and, as used herein, mean any surface with bumps, protrusions, gaps, voids, low spots or the like or any other surface condition or defect which results in or may result in a surface which is not substantially smooth. The irregular wall surface may have defects due to damage or irregularities natural and expected in the type of material from which the wall surface or substrate is made, e.g. concrete block walls or paneling, or its method of manufacture. “Surface irregularities” as used herein means bumps, protrusions, gaps, voids, low spots or any other surface conditions or defects which result in or may result in a surface which is not substantially smooth. The surface irregularities may be due to damage to the wall surface or substrate or be due to the type of material from which the wall surface or substrate is made, or its method of manufacture.

The method of the invention basically comprises installation onto a wall substrate having a wall surface with surface irregularities of a base sheet material having sufficient stiffness, thickness and compressibility to conceal surface irregularities on the wall surface of the wall substrate. Typically, the base sheet is stiff enough to bridge gaps, voids or low spots in the underlying wall surface, sufficiently compressible in the out-of-plane direction so that surface irregularities sticking out of the wall surface (such as a nail head or a small piece of mortar) can press into the base sheet without the base sheet ‘bumping up’ over them, and of sufficient thickness that ‘out-of-the-wall’ irregularities do not protrude through the base sheet.

The base sheet of the invention has sufficient stiffness, thickness and compressibility to conceal surface irregularities, surface roughness, surface indentations, surface bumps, and the like, which may be present on a wall substrate. The result after application of the base sheet will be a substantially smooth wall surface on the wall substrate. The smooth wall surface may then have a decorative wall covering applied thereto or be treated in any other manner known in the art for decorating or finishing a wall surface.

The stiffness of the base sheet will prevent the base sheet material from conforming to any gaps or low spots in the wall, thus contributing to a substantially smooth surface. The base sheet typically will have sufficient stiffness if the bending stiffness is at least about 120 gcm (gram, centimeter). This may be determined by the Taber stiffness method as described in technical Association of the Pulp and Paper Industry (TAPPI) method T489 om-92. This procedure measures the bending moment necessary to deflect the free end of a 38 mm wide vertically clamped specimen 15° from its center line when the load is applied 50 mm away from the clamp. All measurements described herein are adjusted by a multiplying factor of 2 after observing deflection to 7.5° as allowed in the standard method due to high stiffness of the materials. In one preferred aspect of the invention, the base sheet has a bending stiffness of between about 140 and about 180 gcm.

The thickness of the base sheet will be such that surface irregularities found on the wall surface of the wall substrate are concealed without having a sheet so thick that the base sheet and/or any wallcovering to be used thereover creates a wall which is too thick to provide a satisfactory wall surface or one that is not aesthetically pleasing. Generally, the base sheet will conceal out-of plane surface irregularities in the wall substrate such as nail and screw head in gypsum wallboard surfaces and mortar and out-of plane blocks in concrete surfaces. In a preferred aspect of the invention, the base sheet will conceal surface irregularities up to about 0.125 inches (125 mils) thick.

The base sheet typically will have sufficient thickness to provide the desired effect in the method of the invention if the base sheet has a thickness of at least about 0.020 inches. In one preferred aspect of the invention, the thickness will be between about 0.065 and about 0.095 inches.

The base sheet desirably has a compressibility that, in conjunction with the thickness and stiffness, contributes to the ability of the base sheet to conceal defects and irregularities in the wall substrate surface. The base sheet typically will have sufficient compressibility if the basis weight is at least about 3 lbs/100 ft². The basis weight of the sheet is measured in accordance with TAPPI method T410 om-93. In this method the area of several sheets is determined by linear measurement and the mass is determined by weighing. The ratio of mass to area is reported as basis weight. In one preferred aspect of the invention, the basis weight of the base sheet will be between about 4.2 and about 4.8 lbs/100 ft².

The base sheet may be any material which provides sufficient stiffness, thickness, and compressibility to adequately cover the defects or irregularities of the wall surface to be covered and provides a substantially smooth wall surface. While each of these characteristics, stiffness, thickness and compressibility, are to be considered in determining an appropriate material for a base sheet, it is the overall result in the properties of the base sheet which determines that the base sheet has sufficient stiffness, thickness and compressibility to cover the surface irregularities of a wall surface or substrate.

Some materials which may be used include foam, fibrous, synthetic or cellulosic materials, or a combination thereof. It is believed that with these materials, the material should be both at least about 0.020 inches thick and have a bending stiffness of at least about 120 gcm in order to provide the overall properties of the base sheet of sufficient stiffness, thickness and compressibility. In a preferred aspect of the invention, the material is at least about 0.020 inches thick, has a bending stiffness of at least about 160 gcm, and has a basis weight of at least about 3 lbs/100ft².

Another material which may be used for the base sheet is a nonwoven fiber glass mat material. In one aspect of the invention, it has been discovered that where the base sheet is a nonwoven fiber glass mat, the desired characteristics of sufficient stiffness, thickness, and compressibility in the wallcovering composite can be obtained by use of a nonwoven fiber glass mat with a thickness of at least 0.020 inches, or basis weight of at least 3 lbs/100 ft², or bending stiffness of at least 120 gcm. Exemplary nonwoven mats which may be used as a base sheet are described in U.S. Pat. Nos. 5,840,413 and 5,992,288. One example of a satisfactory base sheet is a nonwoven fiber glass mat with a nominal thickness of 0.080 inches, nominal surface density of 4.5 lbs/100 ft² and nominal binder content of 16.5% by weight sold as Johns Manville Dura-Glass® 5045 fiber glass mat. Additional examples of other nonwoven fiber glass mats which may be used as the base sheet in the composite wallcovering of the invention include Dura-Glass® 8447 and Dura-Glass® 8140.

Nonwoven fiber glass mats useful in the present invention typically will contain about 50 to about 90 weight percent fibers and about 8 to about 10 weight percent binder. In a preferred aspect of the invention, the nonwoven glass fiber mats contain about 70 to about 90 weight percent fibers and about 10 to about 30 weight percent binder.

The majority of the fibers in the nonwoven fiber glass mats typically will be glass fibers. However, nonwoven fiber glass mats containing some minority portion of nonglass fibers such as man made or natural organic fibers like synthetic polymer fibers or fibers from cellulose derivatives may be used. Preferably, such nonwoven fiber glass mats will meet fire code requirements. Such nonwoven fiber glass mats are known in the art.

The glass fibers which can be used to make nonwoven fiber glass mats useful for the base sheet may have various fiber diameters and lengths dependent on the strength and other properties desired in the mat. Typically glass fibers having average diameters from about 10 microns to about 20 microns can be used, but preferably from about 13 microns to about 17 microns are used. The fiber lengths of the glass fibers may be all about the same or different fiber lengths can be used. Typically, the length will be about ¾ to about 1¼ inch. The glass fibers can be E, C, T, S or any known type glass fiber of good strength and durability. Preferred fibers include E glass fibers.

Processes for making nonwoven fiber glass mats are well known and some of them are described in U.S. Pat. Nos. 4,112,174, 4,681,802 and 4,810,576, but any known method of making nonwoven mats can be used. Typical techniques for making nonwoven fiber glass mats involve forming a dilute aqueous slurry of fibers and depositing the slurry onto an inclined moving screen forming wire to dewater the slurry and form a wet nonwoven fibrous mat, on machines like a Hydroformer™ manufactured by Voith-Sulzer of Appleton, Wis., or a Deltaformer™ manufactured by Valmet/Sandy Hill of Glenns Falls, N.Y. Next, the wet, unbonded mat is transferred to a second moving screen running through a binder application saturating station where an aqueous binder is applied to the mat in any on of several known ways. The excess binder is removed and the wet mat is transferred to a wire mesh moving belt and passed through an oven to dry the wet mat and to cure (polymerize) the binder which bonds the fibers together in the mat. Preferably, the aqueous binder solution is applied using a curtain coater or a dip and squeeze applicator, but other known methods of application such as spraying will also work. Alternative forming methods for making eh mat include the use of well known paper or board making processes such as cylinder forming, etc. or “dry laying” using carding or random fiber distribution.

The temperatures and times of drying and curing will depend on the binder selected for making the nonwoven fiber glass mat. Any number of binders are known in the art and methods for applying the various binders to form nonwoven fiber glass mats are also known in the art. In a preferred aspect of the invention, the binder is urea formaldehyde, melamine formaldehyde or acrylic.

The wallcovering method of the invention provides a smooth surface to an irregular wall surface in a single installation step. This is a major advantage over known methods for providing a smooth surface on an irregular wall substrate. The wallcovering method of the invention allows for installation of the base sheet in a single step by adhering the base sheet material to the wall wherein the base sheet provides the smooth surface. An additional wallcovering such as wallpaper or other wallcovering material may be used in conjunction with the base sheet in the present method.

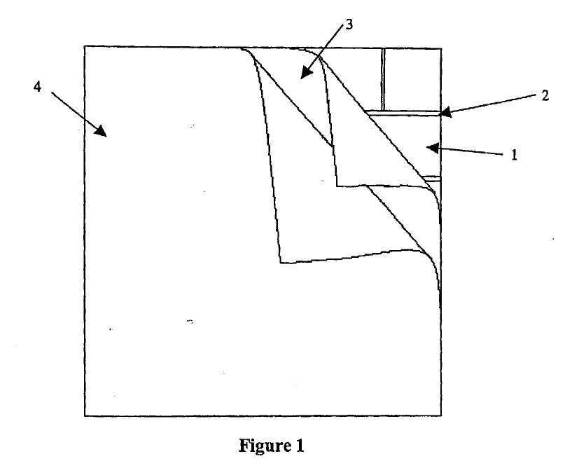

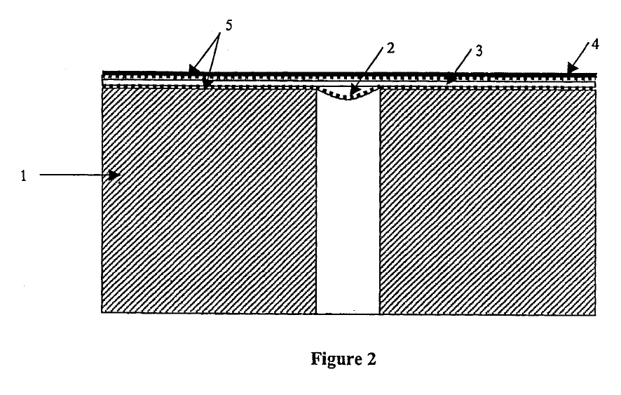

With regard to the examples of the invention shown in the figures, FIGS. 1 and 2 illustrate the method of the invention. As shown, the method involves the application of a base sheet 3, attached to a wall surface 1, by means of a wallcovering or other type of adhesive 5. Adhesive 5 is applied substantially uniformly to the wall surface 1. The base sheet 3 is installed onto the wall surface 1 in a manner similar to standard wallcovering products. The base sheet 3 has a material stiffness sufficient that low spots and voids such as mortar joints 2 (in the case of concrete block wall) are bridged by the base sheet. The finish wallcovering 4 is then attached by applying a layer of adhesive 5 to the entire surface of the base sheet and installing the finish wallcovering 4 per the manufacturer's recommendations.

In addition to concealing low spots and voids in a wall surface, this invention can also conceal small out-of-plane irregularities in the wall surface. These could include nail and screw heads in gypsum wallboard surfaces and mortar and out-of-plane blocks in concrete surfaces. The effectiveness of the base sheet in concealing these irregularities is determined, at least in part, by the compressibility and thickness of the base sheet. In a preferred aspect, the base sheet can conceal surface irregularities of this type up to about 0.125 (⅛) inches thick.

This invention is intended to provide a smooth surface to which wallcovering materials may be applied. The intention is that this method could be used to finish a wall surface in one installation session, with a finish or decorative wallcovering being applied to the base sheet immediately following the installation of the base sheet. This process could considerably shorten the time and cost required to finish an irregular wall surfaces such as unfinished gypsum wallboard, paneling or concrete. Another benefit of this invention is to provide a smooth surface over a rough wall surface with a minimal increase in wall thickness. The primary application of this invention is over concrete masonry unit (CMU) walls, but it could be used over any wall surface with surface irregularities less than or equal to about 0.125 inches out-of plane.

In one example of this invention, the base sheet 3 is a non-woven fiber glass mat, with nominal thickness of 0.080 inches, nominal surface density of 4.5 lbs/100² and nominal binder content of 16.5% by weight (e.g., Johns Manville® 5045 mat). Further examples of the base sheet 3 include any nonwoven fiber glass mat with thickness at least 0.020 inches or basis weight of at least 3 lbs/100 ft² or bending stiffness of at least 120 gcm. Additional examples include any foam, fibrous, synthetic or cellulosic material, or combination thereof, or any nonwoven mat, that is at least 0.020 inches thick and has a bending stiffness of at least 120 gcm.

While the preferred aspects of the invention have been disclosed in detail, it will be apparent to one skilled in the art that various changes and modifications can be made without departing from the spirit and scope thereof.

1. A method for providing a smooth surface to a wall substrate having a wall surface with surface irregularities comprising:
(a) applying an adhesive substantially uniformly to the wall surface and
(b) attaching to the wall surface a base sheet comprising a nonwoven fiber glass mat with sufficient stiffness, thickness and compressibility to conceal the surface irregularities and provide a substantially smooth surface on the wall substrate.

2. The method according to claim 1 wherein the base sheet has a bending stiffness of at least about 120 gcm.

3. The method according to claim 1 wherein the base sheet has a thickness of at least about 0.020 inches.

4. The method according to claim 1 wherein the base sheet has a basis weight of at least about 3 lbs/100 ft².

5. The method according to claim 1 further comprising applying a wallcovering adhesive to the base sheet attached to the wall surface and attaching a finish wallcovering to the base sheet.

6. A method for providing a substantially smooth surface on a wall substrate having a wall surface with surface irregularities comprising:
(a) applying an adhesive substantially uniformly to the wall surface, and
(b) attaching to the wall surface a base sheet having sufficient stiffness, thickness and compressibility to conceal the surface irregularities and provide a substantially smooth surface on the wall substrate.

7. The method according to claim 6 wherein the base sheet has a bending stiffness of at least about 120 gcm and a thickness of at least about 0.020 inches.

8. The method according to claim 7 wherein the base sheet has a basis weight of at least about 3 lbs/100 ft².

9. The method according to claim 6 further comprising applying a wallcovering adhesive to the base sheet attached to the wall surface and attaching a finish wallcovering to the base sheet.

10. A method for providing a smooth surface to a wall substrate having a wall surface with surface irregularities comprising:
(a) applying an adhesive substantially uniformly to the wall surface and
(b) attaching to the wall surface a base sheet having a bending stiffness of at least about 120 gcm, a thickness of at least about 0.020 inches and a basis weight of at least about 3lbs/100 ft.

11. The method according to claim 10 further comprising applying a wallcovering adhesive to the base sheet attached to the wall surface and attaching a finish wallcovering to the base sheet.

12. The method according to claim 10 wherein the base sheet is a nonwoven fiber glass mat.
